(19) United States
(12) Patent Application Publication
(10) Pub. No.: US 2024/0394334 A1
(43) Pub. Date: Nov. 28, 2024

(54) INTELLIGENT HYBRID QUANTUM ANNEALING EXECUTION

(71) Applicant: Dell Products L.P., Round Rock, TX (US)

(72) Inventors: Rômulo Teixeira de Abreu Pinho, Niterói (BR); Brendan Burns Healy, Haddonfield, NJ (US); Miguel Paredes Quiñones, Campinas (BR); Ítalo Gomes Santana, Rio de Janeiro (BR); Victor Fong, Medford, MA (US)

(21) Appl. No.: 18/321,252

(22) Filed: May 22, 2023

(51) Int. Cl. G06F 17/18

(52) U.S. Cl. CPC G06F 17/18

(57) ABSTRACT

One example method includes receiving a quadratic unconstrained binary optimization (QUBO) matrix associated with a QUBO problem, determining a classical computing infrastructure on which to execute a simulated first process to solve the QUBO problem, causing execution of the simulated first process to solve the QUBO problem, wherein the execution of the simulated first process is performed on the classical computing infrastructure, and generates a result, and causing execution of an actual, or simulated, second process to solve the QUBO problem, wherein execution of the simulated second process is performed on a quantum computing infrastructure, and the result is used as a starting point for performance of the second process.

### FIELD OF THE INVENTION

Embodiments of the present invention generally relate to orchestration of quantum computing jobs. More particularly, at least some embodiments of the invention relate to systems, hardware, software, computer-readable media, and methods, for execution of quantum computing jobs on a hybrid infrastructure that comprises classical computing elements and quantum computing elements.

### BACKGROUND

The compilation and execution of a QUBO (quadratic unconstrained binary optimization) problem may take a significant amount of time depending on the complexity of the problem to be solved. In some cases, the final solution obtained for a problem can be an initial solution for a similar one. Being able to identify similar QUBO configurations and leveraging their solutions as an initial starting point for new problems may be an important step in the efficient execution and orchestration of some QUBO jobs.

However, it can be difficult for developers to come up with a static starting point for QUBO execution, since a change in data concerning the QUBO job will likely alter the starting point for the execution. In particular, a developer would have to manually orchestrate the CPU (central processing unit) and GPU (graphics processing unit) based simulated annealing engines, which would require knowledge of the execution environment ahead of time and would require manual re-coding as hardware environments change.

Moreover, not every QUBO problem will have a similar problem that was executed before. Finally, classical and annealing solvers are not always able to generate good initial solutions by themselves, and instead rely on random initializations, which may hamper the progress of the solver as it attempts to converge on a solution to the QUBO problem.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example optimization problem.

FIG. 2 discloses aspects of an example quantum annealing workflow.

FIG. 3 discloses aspects of an example embedding problem.

FIG. 4 discloses performance aspects of some example annealers.

FIG. 5 discloses an example architecture according to one embodiment.

FIG. 6 discloses a method according to one example embodiment.

FIG. 7 discloses a computing entity configured and operable to perform any of the disclosed methods, processes, and operations.

### DETAILED DESCRIPTION OF SOME EXAMPLE EMBODIMENTS

Embodiments of the present invention generally relate to orchestration of quantum computing jobs. More particularly, at least some embodiments of the invention relate to systems, hardware, software, computer-readable media, and methods, for execution of quantum computing jobs on a hybrid infrastructure that comprises classical computing elements and quantum computing elements.

In one embodiment, an automated orchestration platform, or ‘orchestrator,’ is provided that may dynamically execute a QUBO job, or simply a ‘QUBO,’ in a hybrid manner, first in classical annealing hardware such as a CPU and/or GPU, and then on quantum annealing hardware, using quantum annealing processes and/or simulated quantum annealing processes. In an embodiment, while a QUBO is being executed on classical computing hardware, or simply ‘classical hardware,’ the QUBO may transmit a QUBO matrix, or matrices, to the orchestrator, which may determine where to execute a classical simulation of the QUBO. That is, the orchestrator may determine whether to execute the classical simulation on currently available classical hardware, or on a classical simulation engine. The orchestrator may then create a new runtime environment for the classical simulation. The result, or output, of the running of the classical simulation portion may then be used, by the orchestrator, as a starting point for running of the QUBO job in a quantum execution environment. When the quantum execution is completed, the result of the quantum execution may be automatically sent by the orchestrator back to a classical program. In an embodiment, selection of the classical, and quantum, execution environments may be based on the QUBO and one or more user-defined SLOs (service level objectives).

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a higher quality result may be obtained for a QUBO job than is possible with conventional approaches. As another example, an embodiment may dynamically select quantum and classical execution environments based on various inputs so that a hybrid execution environment is employed that is customized to a particular QUBO job. Various other advantages of one or more embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment

Following is a brief discussion concerning various concepts that may relate to one or more embodiments. This discussion is not intended to limit the scope of the invention in any way.

In general, quantum annealers include computational devices configured to solve combinatorial optimization problems, such as QUBO optimization problems. A QUBO model may be expressed by an optimization problem, thus:

QUBO: minimize the function y=x′Qx, where,
x is a vector of binary decision variables, and
Q is a matrix of constants sometimes referred to as a QUBO matrix.

QUBO problems are a type of combinatorial optimization problem such that many real world problems may be encoded in the format (where x∈{0,1}ⁿ):

$$H ( x ) = {\sum }_{i < j} {q}_{i , j} {x}_{i} {x}_{j} + {\sum }_{i} {q}_{i} {x}_{i}^{2} = {x}^{T} Q x$$

Quantum annealing (QA) processes may attempt to interpolate between a static problem-independent Hamiltonian for which the ground state may be efficiently prepared, and a final Hamiltonian whose ground state yields the desired answer. The QA system then linearly interpolates between H₀ and H_{f} (H_{f}=Q).

$$H ( t ) = α ( t ) {H}_{0} + β ( t ) {H}_{f}$$

Where: H_{f} is the Hamiltonian of the problem that is to be solved. This system represented by H(t) evolves following the time-dependent Schrodinger equation. The system is manipulated in the manner of create quantum tunneling effect that makes that the system stay closer to the ground state.

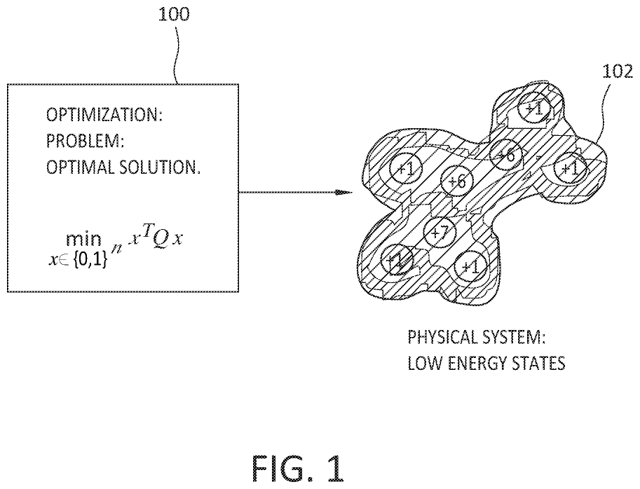

With the foregoing in view, attention is directed to FIG. 1 which discloses an example quantum annealing intuition. Particularly, FIG. 1 discloses an optimization problem solution 100 expressed in terms of, or modeled as, low energy states of a physical system 102.

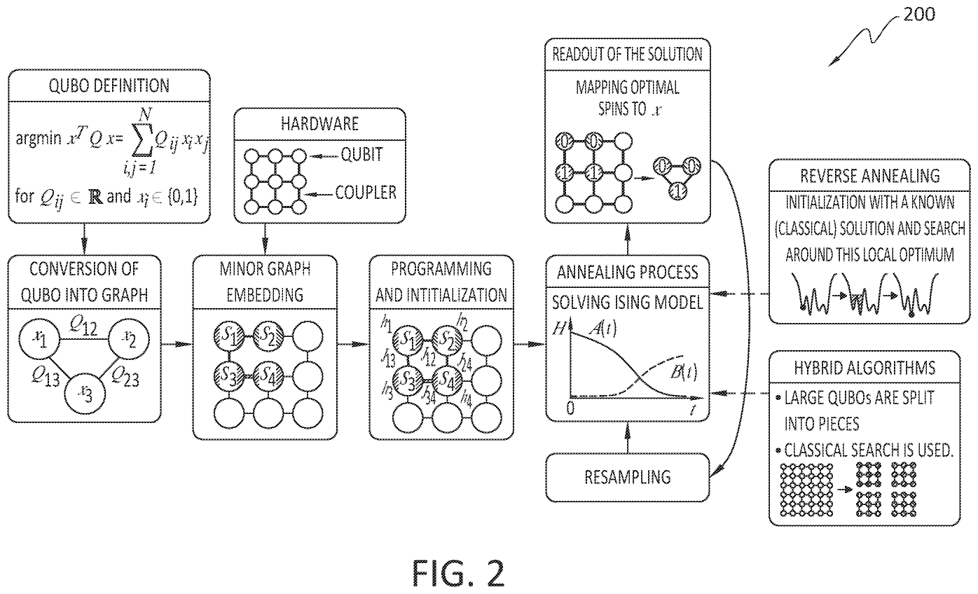

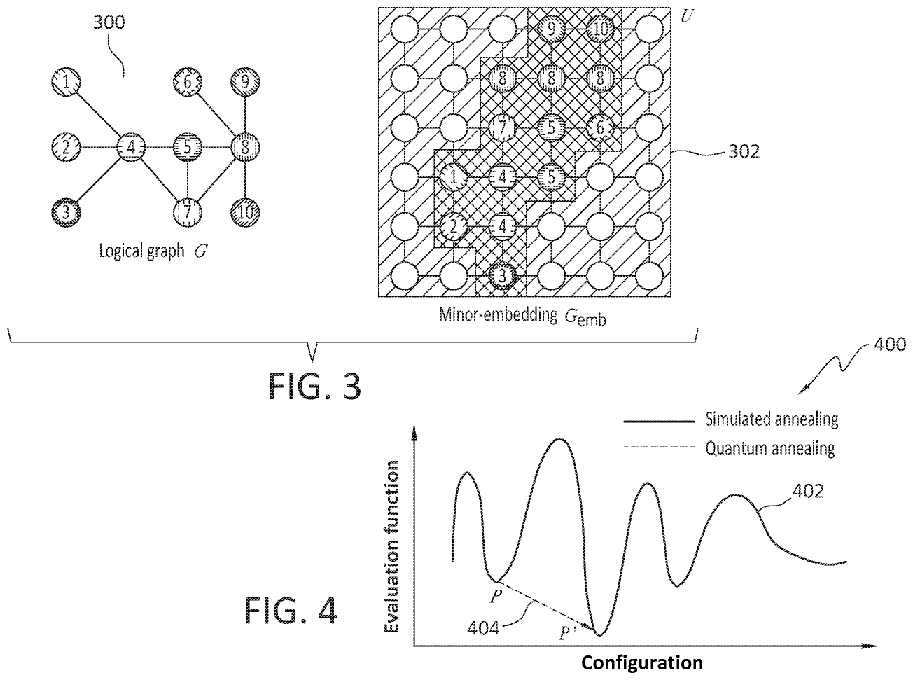

Turning next to FIG. 2, there is discloses an example quantum annealing workflow 200. As shown there, for example, a quantum annealing workflow 200 may involve a minor graph embedding problem, an example of which is disclosed in more detail in FIG. 3.

Particularly, FIG. 3 discloses a logical graph G 300 whose various nodes are to be mapped to qubits implemented in hardware, as shown at 302. Thus, a minor embedding problem may be expressed as the need to map graph nodes to the qubits implemented in the hardware, in order to solve combinatorial optimization problems. In practice, heuristics are used. However, weak embeddings may drastically reduce the number of qubits available for computation, which may prevent the resolution of larger problem instances.

With reference next to FIG. 4, a graph 400 is disclosed that indicates respective behaviors of a simulated annealing process 402, and a quantum annealing process 404. As used herein, simulated quantum annealing (SQA) refers, but is not limited, to computational techniques used to simulate the environment of QA. SQA may be performed using classical computing, such as OpenJiJ for example, classical accelerators such as NEC Corp. vector annealing, or by creating specialized hardware, such as that created by Fujitsu Corp., for simulating the behavior of QA.

As used herein, Simulated Annealing (SA) is a metaheuristic, resembling in some respects an annealing process on metallurgy, where a QUBO can be encoded on the process of controlled cooling, that is, annealing, of a metal. SA can provide good solutions for a large range of problems, but there is evidence that QA may be able find the global minimum/minima of some problems exponentially more quickly than SA would be able to. Thus, whether or not QA and/or SA are used may depend on the particular circumstances involved.

### B. Aspects of an Example Architecture and Associated Operations

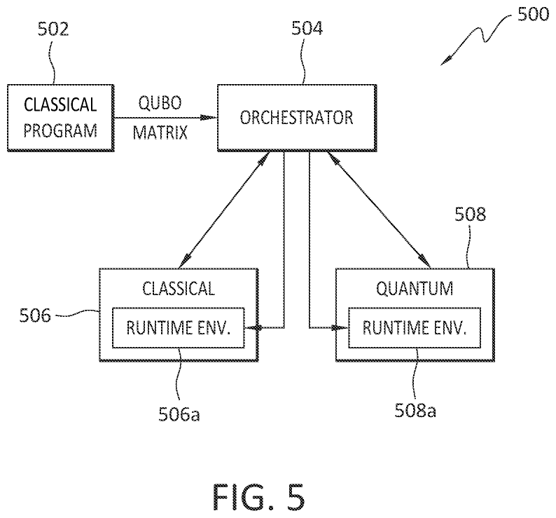

With attention now to FIG. 5, an example architecture according to one embodiment is denoted generally at 500. The following is a discussion of aspects of example operating environments for various embodiments of the invention. This discussion is not intended to limit the scope of the invention, or the applicability of the embodiments, in any way.

In general, CPU and GPU based simulated annealing (classical heuristic) may be relatively less effective than quantum annealing and simulated quantum annealing in producing good solutions to QUBO problems. However, the speed with which this classical hardware, that is CPU/GPU for example, is able to generate a potential solution may make such classical computing hardware attractive for inclusion in a hybrid system, since these potential solutions may be used for a warm start for simulated/actual quantum annealing processes. An example hybrid system, and associated operations, are discussed below.

Thus, an embodiment of the invention may comprise an automated approach for orchestrating various types of annealing processes to respective elements of a hybrid computing environment. In an embodiment, a solution to a QUBO may be obtained that is of relatively higher quality than if the hybrid approach disclosed herein had not been employed. In an embodiment, the use of the hybrid approach to obtain the QUBO solution may be transparent to a user. One particular example embodiment comprises an automated orchestration platform that dynamically executes a QUBO in a hybrid manner, first on classical annealing hardware such as CPU/GPU, then on quantum annealing hardware using either a quantum annealing or simulated quantum annealing process.

With particular reference now to FIG. 5, a QUBO compilation process, which may be run using classical computing hardware such as CPUs and/or GPUs for example, may involve transforming various constraints and parameters of the QUBO into a matrix, which may ultimately be fed to an annealer, or other QUBO solver. That is, the QUBO matrix may comprise a compiled QUBO that is ready for execution.

In an embodiment, the QUBO matrix may be transmitted by a classical program 502, running in the environment 500, to an orchestrator 504. In general, the orchestrator 504 may determine where respective classical, and quantum, simulations of the QUBO will be executed. More particularly, a classical simulation of the QUBO may be executed on classical computing infrastructure 506, which may comprise classical computing hardware components. A quantum annealing, or simulated quantum annealing, of the QUBO may be executed on quantum computing infrastructure 508, which may comprise quantum computing hardware such as one or more quantum annealers for example.

In more detail, the orchestrator 504, upon receiving the QUBO matrix from the classical program 502, may first determine where best to execute a classical simulation of the QUBO, based on currently available classical hardware and classical simulation engines available in the platform. In an embodiment, an ML (machine learning) model may be used to determine the optimal classical annealing execution based, for example, on a user-defined SLO (service-level objective). Example embodiments of such an ML model are disclosed in U.S. patent application Ser. No. 18/321,207, entitled ESTIMATING EXECUTION METRICS OF DIFFERENT ANNEALERS FOR SLO OPTIMIZATION, filed May 22, 2023 and incorporated herein in its entirety by this reference. The final overall cost of execution of the QUBO may thus comprise a sum of a classical execution cost, and a quantum execution cost.

After the orchestrator 504 has decided where to execute the classical simulation portion of the QUBO, the orchestrator may create a new runtime environment 506a, such as a container for example, on the chosen classical execution environment to execute the simulation of the energy corresponding to the QUBO matrix that was provided by the classical program 502. In an embodiment, the classical simulation portion of the QUBO may comprise a simulated classical annealing process that may be executed using classical hardware such as, but not limited to, CPU, GPU, or classical hardware accelerators.

After the classical simulation has been completed on the classical hardware 506, the orchestrator 504 may receive the result, and then create a new execution, or runtime, environment 508a on the quantum component 508, and then run the quantum simulation of the QUBO on the quantum infrastructure 508. The quantum simulation of the QUBO performed on the quantum infrastructure 508 may comprise a quantum annealing process, or simulated quantum annealing process. In an embodiment, the quantum simulation may use the result from the classical simulated annealing performed on the classical hardware infrastructure 506 as a warm starting point. In an embodiment, this result may take the form of a bit string array provided by the classical computing infrastructure 506 to the orchestrator 504. After execution of the quantum simulation of the QUBO on the quantum infrastructure 508 has been completed, the result, which may again comprise a bit string array, may be sent back to the classical program 502 by the orchestrator 504.

### C. Example Methods

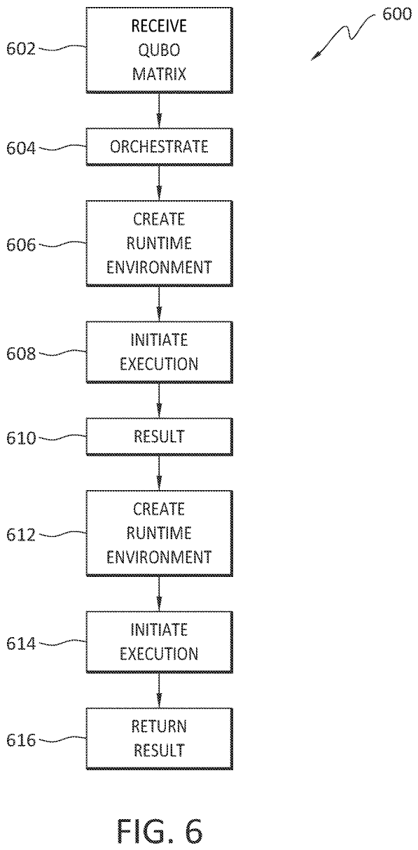

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, a method according to one example embodiment is generally indicated at 600. In an embodiment, part or all of the method 600 may be performed by, and/or at the direction of, an orchestrator, examples of which are disclosed herein.

Initially, an orchestrator may receive 602 a QUBO matrix from a classical program. The orchestrator may then orchestrate 604 a simulated classical execution of the QUBO to a classical computing infrastructure. The simulated classical execution of the QUBO may comprise a simulated classical annealing process.

In order to enable performance of the simulated classical execution of the QUBO, a runtime environment may be created 606 in the classical computing infrastructure. The simulated classical execution of the QUBO may then be initiated 608, and the simulated classical execution of the QUBO performed in the runtime environment using the classical computing infrastructure.

The simulated classical execution of the QUBO may generate various results 610. Such results 610 may comprise, for example, a solution to the QUBO. In an embodiment, the results may comprise a bit string array, but that is not necessarily required.

After the simulated classical execution of the QUBO has been completed, a runtime environment may be created 612 in a quantum computing infrastructure. The simulated quantum execution of the QUBO may then be initiated 614, and the simulated quantum execution of the QUBO performed in the runtime environment using the quantum computing infrastructure. In an embodiment, the simulated quantum execution of the QUBO may comprise a quantum annealing process, or a simulated quantum annealing process.

The simulated quantum execution of the QUBO may generate various results which may be returned 616 to the classical program from which the QUBO matrix was received 602, and/or may be returned 616 to another recipient. Such results may comprise, for example, a solution to the QUBO. In an embodiment, the results may comprise a bit string array, but that is not necessarily required.

### D. Further Discussion

As is apparent from this disclosure, one or more embodiments may possess various useful features and aspects. For example, an embodiment may comprise an automated hybrid system that utilizes both classical and quantum components to produce a higher quality result, as compared with a result that may be achieved with a system that does not use a hybrid approach, by using a classical simulated annealing result as a warm start for a quantum annealing or simulated quantum annealing process. As another example, an embodiment may perform a dynamic selection of both classical and quantum execution environments based on, for example, QUBO and user-defined service-level objectives.

### E. Further Example Embodiments

Following are some further example embodiments of the invention. These are presented only by way of example and are not intended to limit the scope of the invention in any way.

Embodiment 1. A method, comprising: receiving a quadratic unconstrained binary optimization (QUBO) matrix indicative of a QUBO problem; determining a classical computing infrastructure on which to execute a simulated first process to solve the QUBO problem; causing execution of the simulated first process to solve the QUBO problem, wherein the execution of the simulated first process is performed on the classical computing infrastructure, and generates a result; and causing execution of an actual, or simulated, second process to solve the QUBO problem, wherein execution of the simulated second process is performed on a quantum computing infrastructure, and the result is used as a starting point for performance of the second process.

Embodiment 2. The method as recited in any preceding embodiment, wherein the classical computing infrastructure comprises one or more processing units.

Embodiment 3. The method as recited in any preceding embodiment, wherein the quantum computing infrastructure comprises quantum computing hardware.

Embodiment 4. The method as recited in any preceding embodiment, wherein the simulated first process comprises a classical annealing process.

Embodiment 5. The method as recited in any preceding embodiment, wherein the second process comprises a quantum annealing process, or a simulated quantum annealing process.

Embodiment 6. The method as recited in any preceding embodiment, wherein the determining of the classical computing infrastructure, on which to perform the execution of the simulated first process, is performed automatically based in part on the QUBO matrix.

Embodiment 7. The method as recited in any preceding embodiment, wherein a runtime environment is created in the classical computing infrastructure, and the execution of the simulated first process is performed in the runtime environment.

Embodiment 8. The method as recited in any preceding embodiment, wherein a runtime environment is created in the quantum computing infrastructure, and the execution of the second process is performed in the runtime environment.

Embodiment 9. The method as recited in any preceding embodiment, wherein the determining of the classical computing infrastructure on which to perform the execution of the simulated first process is performed automatically based in part on available classical hardware and/or one or more available classical simulation engines.

Embodiment 10. The method as recited in any preceding embodiment, wherein a quality of a result obtained by execution of the second process is relatively better than the result obtained by execution of the simulated first process.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers. Other annealers may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

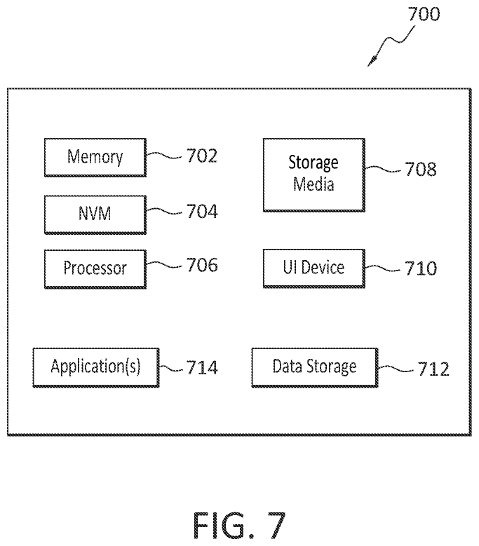

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a quadratic unconstrained binary optimization (QUBO) matrix indicative of a QUBO problem;
determining a classical computing infrastructure on which to execute a simulated first process to solve the QUBO problem;
causing execution of the simulated first process to solve the QUBO problem, wherein the execution of the simulated first process is performed on the classical computing infrastructure, and generates a result; and
causing execution of an actual, or simulated, second process to solve the QUBO problem, wherein execution of the simulated second process is performed on a quantum computing infrastructure, and the result is used as a starting point for performance of the second process.

2. The method as recited in claim 1, wherein the classical computing infrastructure comprises one or more hardware processing units.

3. The method as recited in claim 1, wherein the quantum computing infrastructure comprises quantum computing hardware.

4. The method as recited in claim 1, wherein the simulated first process comprises a classical annealing process.

5. The method as recited in claim 1, wherein the second process comprises a quantum annealing process, or a simulated quantum annealing process.

6. The method as recited in claim 1, wherein the determining of the classical computing infrastructure, on which to perform the execution of the simulated first process, is performed automatically based in part on the QUBO matrix.

7. The method as recited in claim 1, wherein a runtime environment is created in the classical computing infrastructure, and the execution of the simulated first process is performed in the runtime environment.

8. The method as recited in claim 1, wherein a runtime environment is created in the quantum computing infrastructure, and the execution of the second process is performed in the runtime environment.

9. The method as recited in claim 1, wherein the determining of the classical computing infrastructure on which to perform the execution of the simulated first process is performed automatically based in part on available classical hardware and/or one or more available classical simulation engines.

10. The method as recited in claim 1, wherein a quality of a result obtained by execution of the second process is relatively better than the result obtained by execution of the simulated first process.

11. A non-transitory storage medium having stored therein instructions that are executable by one or more hardware processors to perform operations comprising:
receiving a quadratic unconstrained binary optimization (QUBO) matrix indicative of a QUBO problem;
determining a classical computing infrastructure on which to execute a simulated first process to solve the QUBO problem;
causing execution of the simulated first process to solve the QUBO problem, wherein the execution of the simulated first process is performed on the classical computing infrastructure, and generates a result; and
causing execution of an actual, or simulated, second process to solve the QUBO problem, wherein execution of the simulated second process is performed on a quantum computing infrastructure, and the result is used as a starting point for performance of the second process.

12. The non-transitory storage medium as recited in claim 11, wherein the classical computing infrastructure comprises one or more processing units.

13. The non-transitory storage medium as recited in claim 11, wherein the quantum computing infrastructure comprises quantum computing hardware.

14. The non-transitory storage medium as recited in claim 11, wherein the simulated first process comprises a classical annealing process.

15. The non-transitory storage medium as recited in claim 11, wherein the second process comprises a quantum annealing process, or a simulated quantum annealing process.

16. The non-transitory storage medium as recited in claim 11, wherein the determining of the classical computing infrastructure, on which to perform the execution of the simulated first process, is performed automatically based in part on the QUBO matrix.

17. The non-transitory storage medium as recited in claim 11, wherein a runtime environment is created in the classical computing infrastructure, and the execution of the simulated first process is performed in the runtime environment.

18. The non-transitory storage medium as recited in claim 11, wherein a runtime environment is created in the quantum computing infrastructure, and the execution of the second process is performed in the runtime environment.

19. The non-transitory storage medium as recited in claim 11, wherein the determining of the classical computing infrastructure on which to perform the execution of the simulated first process is performed automatically based in part on available classical hardware and/or one or more available classical simulation engines.

20. The non-transitory storage medium as recited in claim 11, wherein a quality of a result obtained by execution of the second process is relatively better than the result obtained by execution of the simulated first process.
